(19) United States
(12) Patent Application Publication
(10) Pub. No.: US 2024/0215601 A1
(43) Pub. Date: Jul. 4, 2024

(54) COMPOSITIONS AND METHODS FOR INHIBITING OXIDATION OF NATURAL OIL BASED COMPOSITION USING AMINOPHENOL ANTIOXIDANT

(71) Applicant: Ecolab USA Inc., St. Paul, MN (US)

(72) Inventors: Ashish Dhawan, Aurora, IL (US); Carter M. Silvernail, Lakeville, MN (US)

(21) Appl. No.: 18/390,789

(22) Filed: Dec. 20, 2023

Related U.S. Application Data
(60) Provisional application No. 63/434,274, filed on Dec. 21, 2022.

(51) Int. Cl. A23D 9/06; C09D 7/48; C09D 7/63; C09D 191/00; C10L 1/02; C10L 1/223; C10M 105/34; C10M 133/14

(52) U.S. Cl. CPC A23D 9/06; C09D 7/48; C09D 7/63; C09D 191/00; C10L 1/026; C10L 1/2235; C10M 105/34; C10M 133/14; C10L 2200/0476; C10L 2230/081; C10M 2207/401; C10M 2215/26; C10N 2030/10

(57) ABSTRACT

Compositions including a vegetable- or animal-derived oil, such as fatty acid alkyl esters, are stabilized against oxidation using an oxygenated aminophenol antioxidant. The aminophenol includes one or two carbon-containing group(s) including a hydroxyl group and/or ether group separated from the N atom by one or more carbon atoms. The oxygenated aminophenol antioxidants effective at controlling oxidation at moderate and even low amounts, useful in a variety of different oil and methyl ester fatty acid preparations, and were effective at elevated temperatures, and performed significantly better than convention antioxidants.

### CROSS REFERENCE TO RELATED APPLICATIONS

This application claims the benefit of U.S. Provisional Patent Application Ser. No. 63/434,274, filed Dec. 21, 2022, the disclosure of which is incorporated in its entirety herein by reference.

### TECHNICAL FIELD

The invention is directed towards using aminophenol antioxidants to inhibit oxidation of oxidizable compounds in natural oils or materials made therefrom, such as fuel and lubricant compositions like biodiesel and biolubricants.

### BACKGROUND

Antioxidants are used in various types of compositions and industries. For example, antioxidants are used to inhibit chemical oxidation of compositions obtained in the petroleum and gas industries. Antioxidants also play important roles as food preservatives, and are often added to various food compositions to preserve food properties.

Hydrocarbon-containing compositions can benefit from use of antioxidants. In fats and oils, antioxidants can inhibit oxidation reactions which can otherwise undesirably affect the chemistries of such fats and oils. Natural fats and oils include fatty acid portions that may have regions of unsaturation that are highly susceptible to oxidation. In food products, the oxidation of edible fats and oils can lead to unpleasant odors and tastes, causing spoilage of the food. Oxidation can be caused by exposure to oxygen and sunlight that lead to oxidation of hydrocarbons.

Antioxidants are also added to fuels, such as gasoline and gasoline/ethanol blends, and lubricants to prevent oxidation of hydrocarbons therein. Gasoline fuels can oxidize easily upon exposure to conditions such as heat, oxygen, and ultraviolet light. Oxidation products result in gum or sediment within the fuel and thereby leading to problems such as plugging and corrosion of internal combustion engines. Antioxidants can prevent the polymerization of compounds in gasoline otherwise leading to residues that can damage internal combustion engines.

As an alternative to fuels and lubricants obtained from fossil sources, there has been more interest the use of renewable raw materials to produce biofuels and lubricants. In particular, biodiesel fuel and biolubricants have gained in popularity due to their performance properties, which can be similar and, in some cases, superior to petroleum-based fuels and lubricants. Biodiesel and biolubricants are typically derived from raw materials that are vegetable oils (i.e., glycerides), for example, soy, palm, rapeseed, sunflower, and coconut oils. These oils are typically converted to fatty acid alkyl esters by a transesterification reaction. Most commonly the transesterification process reacts the oils with methanol under basic catalysis to generate fatty acid methyl esters (FAMEs). While the use of biodiesel and biolubricants offers great commercial potential, there are various technical challenges associate with their preparation and use.

One challenge for the preparation and use of biodiesel and biolubricants is preserving the oxidation stability of these compositions. While vegetable oil raw materials have some protection from oxidation by naturally occurring antioxidants like tocopherols, the manufacturing and refining processes for biodiesel and biolubricants can remove these natural antioxidants.

Without antioxidants, a reduction in the oxidation stability of the biodiesel and biolubricants are susceptible to oxidative degradation. Oxidative biodiesel composition may deteriorate the properties of the biodiesel and cause problems with its use. Fatty acid esters in degradation can be caused and accelerated by factors such as contaminants like trace metals, contact with metal surfaces, aeration, and physical factors such as heat and ultraviolet light. For example, oxidation of biodiesel components by interaction with air and metal surfaces results in the formation of hydroperoxide radicals. These radicals promote free-radical chain reactions that cause the formation of oxidized chemical compounds of low molecular weight, like acids, aldehydes, and ketones. Polymeric gums are also formed as a result of oxidation. Polymeric gums lead to many problems such as inadequate fuel combustion, deposits on engine parts such as injectors and pistons, and plugging of injectors and fuel lines. Therefore, oxidation not only reduces the effectiveness of the biodiesel, but it also causes long term mechanical problems in the engine and associated parts.

Antioxidants are preferably used in biodiesel and biolubricants to prevent the oxidation of components therein such as FAMEs. However, the use of known antioxidants can be challenging. Some conventional antioxidants are required need to be used at elevated concentrations to be useful as antioxidants, but often these antioxidants are not very effective in controlling peroxides formation as a result of interaction of the biodiesel with air. First, the antioxidant should be compatible with bio-based fuels and lubricants that are derived from a wide variety of plant-based materials, and should not demonstrate any adverse interactions with components in the bio-based compositions. Also, the antioxidant should be compatible with biodiesel blends, such as biodiesel that includes blends of (plant-based) biodiesel with petroleum-derived diesel. Also, added antioxidants should not adversely impact the properties of these materials, such as ignition and combustion properties, and also flow properties of biodiesel, especially flow properties of biodiesel at low temperatures. Further, added antioxidants should also cause minimal environmental impact, especially when used with biodiesel, such as to not promote the formation of unwanted airborne particulates. Some conventional antioxidants include sulfur chemistries, the use of which can be undesirable from an environmental standpoint.

### SUMMARY

The current disclosure is directed to compositions including or derived from a natural oil. that use an oxygenated aminophenol antioxidant according to the chemistries described herein. The oxygenated aminophenol antioxidant provides excellent antioxidant properties to compositions that include natural oils or materials made from natural oils, such as bio-based fuels and lubricants, like biodiesel and biolubricants. Further, the oxygenated aminophenol antioxidant does not compromise the properties of the composition that includes the natural oil or natural oil-derived materials. For example, aminophenol antioxidant can be included in a biodiesel or biolubricant composition without compromising important properties, such as combustion properties, lubricity, and flow properties at low temperatures.

Experimental studies associated with aspects of the disclosure revealed that moderate and even low amounts of the oxygenated aminophenol antioxidants of the disclosure were effective at controlling oxidation of natural oil-based composition. The oxygenated aminophenol antioxidants also showed effectiveness as antioxidants in a variety of different natural oil derivatives, in particular, methyl ester fatty acid preparations, illustrating their usefulness as antioxidants of a wide variety of natural oil-based compositions, including biodiesel and biolubricant compositions. Further, oxygenated aminophenol antioxidants of the disclosure were effective at elevated temperature testing conditions, supporting their use in higher-temperature processing, storage, and use methods. In turn, the oxygenated aminophenol antioxidants of the disclosure can provide improved oxidation stability that, for uses such as biodiesel, reduces or eliminates sedimentation and gum formation when used in engines and also reduces corrosion and plugging of parts of diesel engines.

Accordingly, in one embodiment the invention provides (ai) an ester of a vegetable-derived fatty acid, (aii) a vegetable-derived oil, or both (ai) and (aii), and (b) an oxygenated aminophenol antioxidant of Formula I:

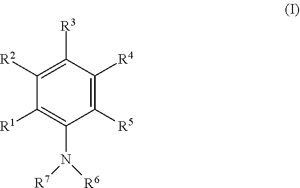

In Formula I, —R¹, —R², —R³, —R⁴, and —R⁵ are independently selected from —H, —OH, alkyl, aryl, alkyl aryl and aryl alkyl, and —NR⁸R⁹, with at least one of —R¹, —R², —R³, —R⁴, and —R⁵ being —OH. R⁸ and R⁹ are independently selected from —H, alkyl, aryl, alkyl aryl and aryl alkyl, and R⁶/R⁷ as described herein, or any two adjacent groups of —R¹, —R², —R³, —R⁴, and —R⁵ form one or more ring structures. One or both of R⁶ and R⁷ is or are (i) a carbon-containing group including (I) one or more hydroxyl group(s), (II) one or more ether groups, or both (I) and (II), separated from the N atom by one or more carbon atoms; if R⁶ or R⁷ is not (i) then it is selected from —H, alkyl, aryl, alkyl aryl and aryl alkyl. The one or more hydroxyl group(s) and/or one or more ether groups.

In embodiments, one or both of R⁶ and R⁷ are of the formula: —(CR¹⁰₂)_{q}(CHOH)(CH₂)_{z}R¹¹, where R¹⁰ is independently selected from —H and alkyl, wherein q and z are independently (—) (a covalent bond), or an integer in the range of 1-12, preferably (—), 1, or 2, and R¹¹ is selected from the group consisting of C1-C24 linear, branched, or cyclic alkyl, aryl, alkyl-aryl, and aryl-alkyl. In embodiments, R¹⁰ is —H; q is 1; z is (—); and R¹¹ is C1-C18 linear, branched, or cyclic alkyl, aryl, alkyl-aryl, and aryl-alkyl.

In embodiments, one or both of R⁶ and R⁷ are of the formula:—(CR¹⁰₂)_{q}(CHOH)(R¹²O)_{z}R¹¹, where R¹⁰ is independently selected from —H and alkyl, q is (—) (a covalent bond) or an integer in the range of 1-12, preferably (—), 1, or 2, R¹¹ is selected from the group consisting of C1-C24 linear, branched, or cyclic alkyl, aryl, alkyl-aryl, and aryl-alkyl, and R¹² is independently selected from —(CH₂)_{w}—, wherein w is 1, 2, or 3, and z is an integer in the range of 1-5. In embodiments, R¹⁰ is —H; q is 1; z is 1; w is 1 or 2, and R¹¹ is C1-C18 linear, branched, or cyclic alkyl, aryl, alkyl-aryl, and aryl-alkyl.

In embodiments, the ester of the vegetable-derived fatty acid comprises (1) an ester, such as a methyl ester, of a vegetable-derived triglyceride, (2) an ester, such as a methyl ester, of a vegetable-derived free-fatty acid, or both (1) and (2). In embodiments, the aminophenol antioxidant of Formula I is present in the composition in an amount in the range of 100 ppm to 2500 ppm, or an amount in the range of 250 ppm to 1500 ppm.

The oxygenated aminophenol antioxidant of the disclosure generally outperformed comparative antioxidants in oxidation stability tests. In experimental studies associated with the disclosure, the Rancimat test (e.g., Standard Test Method EN 14112) was performed to measure degradation products produced from the oxidation of oxidizable components of an oil or oil derivative composition, such as fatty acid methyl esters. Testing is performed using a specified amount of oil/oil derivative and antioxidant, and at a specified air flow rates and temperature. Induction periods were measured, with longer induction periods reflecting antioxidants that performed better comparatively. In some embodiments, the oxygenated aminophenol antioxidant can prolong the induction time for a period of time that is greater than 50% as compared to the induction time without an antioxidant, or for a period of time that is greater than 60%, 70%, 80%, 90%, 100%, or 110% of the induction time without an antioxidant, and up to 275%, 250%, 225%, 200%, 175%, 160%, 150%, 140%, 130%, or up to 125% as compared to the induction time without an antioxidant. Comparative antioxidants, on the other hand, generally did not prolong the induction time more than 50% of the induction time without an antioxidant.

In another embodiment, the invention provides a method for inhibiting oxidation of an ester of a vegetable-derived fatty acid, or of a vegetable-derived oil in a composition comprising. The method includes a step of adding an aminophenol antioxidant to a composition comprising (ai) an ester of a vegetable-derived fatty acid, (aii) a vegetable-derived oil, or both (ai) and (aii), wherein the aminophenol antioxidant is a compound of Formula I.

In some embodiments of the method, the aminophenol antioxidant inhibits oxidation of the ester or the oil at a level greater than 1.4× than the level of oxidation in the absence of the oxygenated aminophenol antioxidant.

The oxygenated aminophenol antioxidant can prevent carbon-carbon double bonds of the alkyl ester fatty acids from becoming oxidized, resulting in the formation of epoxide and alcohol compounds, which can otherwise promote metal corrosion. Biodiesel and lubricity compositions including alkyl ester fatty acids can suffer from this oxidation after periods of exposure to air, and the oxygenated aminophenol antioxidant can be useful as an antioxidant for preventing the deterioration of such compositions.

### DETAILED DESCRIPTION

Although the present disclosure provides references to preferred embodiments, persons skilled in the art will recognize that changes may be made in form and detail without departing from the spirit and scope of the invention. Reference to various embodiments does not limit the scope of the claims attached hereto. Additionally, any examples set forth in this specification are not intended to be limiting and merely set forth some of the many possible embodiments for the appended claims.

Additional advantages and novel features of the invention will be set forth in part in the description that follows, and in part will become apparent to those skilled in the art upon examination of the following, or may be learned through routine experimentation upon practice of the invention.

The disclosure describes compositions that includes natural oils or derivatives thereof, the compositions include an aminophenol antioxidant according to Formula I as described herein. Exemplary compositions include bio-based fuels and lubricants, as exemplified by biodiesel and biolubricants that include the aminophenol antioxidant. The aminophenol antioxidant provides excellent antioxidant properties to the compositions the antioxidant is incorporated into. Further, the aminophenol antioxidant is compatible with the natural oils and derivatives thereof. For example, the aminophenol antioxidant does not compromise the properties of the biodiesel and biolubricants, such as combustion properties, lubricity, and flow properties at low temperatures.

A composition including the essential component(s) of an ester of a vegetable-derived fatty acid and/or a vegetable-derived oil along with the aminophenol antioxidant, can optionally include other components in the composition (e.g., described in terms of a composition “comprising” the ester of a vegetable-derived fatty acid/oil and the aminophenol antioxidant). For example, compositions of the disclosure can include other components such as a solvent, or other additives like a surfactant, dispersant, etc. If an optional component is present in the composition, it may be described in terms of a percentage weight amount (e.g., such as mg/L, or parts per million (ppm)), or a molar amount. Any optional component can alternatively be described in relation to the aminophenol antioxidant, such as whether the optional component is present in an amount greater, an amount less, or an amount that is equal to the aminophenol antioxidant, or can be more specifically described as a ratio (e.g., molar), or a ratio range, between the optional component and the aminophenol antioxidant.

As used herein, the term “optional” or “optionally” means that the subsequently described object (e.g., compound), event (e.g., processing step), amount, or circumstance may, but need not occur, and that the description includes instances where the object, event, amount, or circumstance occurs and instances in which it does not.

Compositions of the disclosure can include those recited compounds and optionally can include other components in the composition but in very small amounts (e.g., described in terms of a composition “consisting essentially of” the recited components). For example, such compositions can include one or more other components but not in an amount that is greater than: about 1% (wt), about 0.5% (wt), about 0.1% (wt), about 0.05% (wt), or about 0.01% (wt) of the total composition. In a composition “consisting of” the recited components there is no other measurable amount of component other than the recited component.

Likewise, the chemistries of compounds of the disclosure, including the naphthoquinone and hydroxylamine can, in some embodiments, be described in terms of the compound “consisting of” certain atoms or certain chemical groups. For example, in embodiments of the disclosure a compound, such as the aminophenol antioxidant, can consist of carbon (C), hydrogen (H), oxygen (O), and nitrogen (N), and will not have any other types of atoms aside from C, H, O, and N, in the compound.

As used herein, the terms “substantially” and “consisting essentially of” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Examples of intended properties include, solely by way of nonlimiting examples thereof, dispersibility, stability, rate, solubility, and the like; intended values include weight of a component added, concentration of components added, and the like. The effect on methods that are modified include the effects caused by variations in type or amount of materials used in a process, variability in machine settings, the effects of ambient conditions on a process, and the like wherein the manner or degree of the effect does not negate one or more intended properties or results; and like proximate considerations. Where modified by the term “substantially” or “consisting essentially of,” the claims appended hereto include equivalents to these types and amounts of materials.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe any range of values, for example “about 1 to 5” the recitation means “1 to 5” and “about 1 to about 5” and “1 to about 5” and “about 1 to 5” unless specifically limited by context.

Some R groups in formulas of the disclosure can include hydrocarbon-containing groups such as alkyl groups, including linear, branched, and cyclic alkyl groups, aryl groups, alkyl aryl groups (e.g., ethyl-benzyl), aryl alkyl groups (e.g., propyl-phenyl), and combinations thereof. In some embodiments, hydrocarbon groups of formulas of the disclosure can be defined by the number of carbon atoms in the group, such as 1-12 carbons, 1-10 carbons, 1-8 carbons, 1-6 carbons, 1-5 carbons, 1-4 carbons, or 1-3 carbons.

Compositions and methods of the disclosure include or use oxygenated aminophenol compounds. The oxygenated aminophenol compounds include, in the least, an unsaturated 6 carbon ring structure having at least one hydroxyl bonded to an aromatic ring carbon, at least one nitrogen atom of a secondary or tertiary amine group bonded to an aromatic ring carbon, with the nitrogen atom of the secondary or tertiary amine group attached to a (first) carbon-containing group (and optionally a second carbon-containing group), that includes one or more hydroxyl group(s) and/or ether group(s) separated from the N atom by one or more carbon atoms. Preferably, the (first) carbon-containing group (and optionally a second carbon-containing group), includes one or more hydroxyl group(s) and one or more ether group(s) separated from the N atom by one or more carbon atoms. Preferably, hydroxyl group and ether group are separated from the nitrogen by two carbon atoms, or by three carbon atoms. Atoms on the aromatic ring that are not bonded to the secondary or tertiary amine group, and the hydroxyl group, can be bonded to a hydrogen atom, a hydrocarbon group including an aryl and/or alkyl group(s), or can form a ring structure (e.g., forming a fused ring structure with the aromatic ring) Exemplary compounds of the disclosure that include a hydroxyl group bonded to a ring atom of an unsaturated 6 carbon ring include those based on phenol, pyrocatechol, resorcinol, hydroquinone, hydroxyl-hydroquinone, or phlorolucitol. Exemplary compounds also include those based on hydroxyl-containing fused aromatic chemistries such as naphthol, hydroxyl-anthracene, or indenol.

In embodiments, the first and/or second carbon-containing group(s) of the secondary or tertiary amine group include: a number of carbon atoms in the range of 1 to about 24, 2 to about 23, 2 to about 22, 3 to about 24, or 4 to about 24; a number of hydrogen atoms in the range of 3 to about 40, 4 to about 38, or 5 to about 35; a number of oxygen atoms of 1, 2, 3, or 4; or any combination thereof. In preferred embodiments, the carbon containing groups of the secondary or tertiary amine group include only carbon, oxygen, and hydrogen.

In some embodiments, the current disclosure provides “bis” compounds wherein the compound includes a tertiary amine group, and the first carbon-containing group and the second carbon-containing group bonded to the nitrogen atom of the tertiary amine group are the same. For example, in the aminophenol compound 4-bis[(3-butoxy-2-hydroxy-propyl)amino]phenol, the first and second carbon-containing groups are the same and are —(CH₂CHOHCH₂)O(CH₂)₃CH₃.

Oxygenated aminophenol antioxidant compounds of the disclosure are described with reference to Formula I:

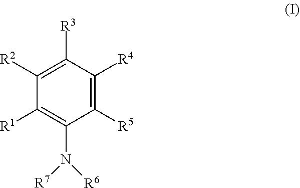

In Formula I, —R¹, —R², —R³, —R⁴, and —R⁵ are independently selected from —H, —OH, alkyl, aryl, alkyl aryl and aryl alkyl, and —NR⁸R⁹, with at least one of —R¹, —R², —R³, —R⁴, and —R⁵ being —OH. R⁸ and R⁹ are independently selected from —H, alkyl, aryl, alkyl aryl and aryl alkyl, and R⁶/R⁷ as described herein, or any two adjacent groups of —R¹, —R², —R³, —R⁴, and —R⁵ form one or more ring structures. One or both of R⁶ and R⁷ is or are (i) a carbon-containing group including (I) one or more hydroxyl group(s), (II) one or more ether groups, or both (I) and (II), separated from the N atom by one or more carbon atoms; if R⁶ or R⁷ is not (i) then it is selected from —H, alkyl, aryl, alkyl aryl and aryl alkyl.

Exemplary alkyl groups that can be one or more of —R¹, —R², —R³, —R⁴, —R⁵, —R⁸, and —R⁹ can be alkyl groups having a number of carbon atoms in the range of 1-18, 1-12, 1-8, 1-6, or 1-3, and selected from linear, branched, and cyclic alkyl groups. Exemplary alkyl group species include, but are not limited to:
methyl,
ethyl,
propyl, isopropyl,
butyl, isobutyl, sec-butyl, tert-butyl,
pentyl, cyclopentyl, isopentyl, neopentyl,
hexyl, cyclohexyl, 1-, 2-, and 3-methylbutyl, 1,1-, 1,2-, or 2,2-dimethylpropyl, 1-ethyl-propyl, 1-, 2-, 3-, or 4-methylpentyl, 1,1-, 1,2-, 1,3-, 2,2-, 2,3-, or 3,3-dimethylbutyl, 1- or 2-ethylbutyl, 1-ethyl-1-methylpropyl, and 1,1,2- or 1,2,2-trimethylpropyl, methylcyclopentyl;
heptyl, 2-methylhexyl, 3-methylhexyl, 4-methylhexyl, 5-methylhexyl, 3-ethylpentyl, 2,2,3-trimethylbutyl, 2,2-dimethylpentyl, 2,3-dimethylpentyl, 2,4-dimethylpentyl, 3,3-dimethylpentyl, 3,4-dimethylpentyl, 4,4-dimethylpentyl, cycloheptyl, 1-methylcyclohexyl, and 2-methylcyclohexyl;
octyl, 2-methylheptyl 3-methylheptyl, 4-methylheptyl, 2-ethylhexyl, 3-ethylhexyl, 4-ethylhexyl, 5-ethylhexyl, 2,2-dimethylhexyl, 2,3-dimethylhexyl, 2,4-dimethylhexyl, 2,5-dimethylhexyl, 3,3-dimethylhexyl, 3,4-dimethylhexyl, 3-ethyl-2-methylpentyl, 3-ethyl-3-methylpentyl, 2,2,3-trimethylpentyl, 2,2,4-trimethylpentyl, 2,3,3-trimethylpentyl, 2,3,4-trimethylpentyl, and 2,2,3,3-tetramethylbutyl;
nonyl, decyl, undecyl, dodecyl, tridecyl, tetradecyl, pentadecyl, hexadecyl, heptadecyl, and octadecyloxy.

Exemplary alkyl aryl groups that can be one or more of —R¹, —R², —R³, —R⁴, —R⁵, —R⁸, and —R⁹ can be alkyl aryl groups having a number of carbon atoms in the range of 7-18 or 7-12, such as phenmethyl, phenethyl, phenpropyl, phenisopropyl, phenbutyl, penisobutyl, phen-sec-butylene, phen-tert-butylene, phen-pentylene, and hexylene, etc.

Exemplary aryl alkyl groups that can be one or more of —R¹, —R², —R³, —R⁴, —R⁵, —R⁸, and —R⁹ can be aryl alkyl groups having a number of carbon atoms in the range of 7-18 or 7-12, such as methyl-phenyl, ethyl-phenyl, propyl-phenyl, butyl-phenyl, pentyl-phenyl, hexyl-phenyl, heptyl-phenyl, and octyl-phenyl.

In embodiments, in one or both of R⁶ and R⁷, one or more hydroxyl group(s) and/or ether group(s) are separated from the N atom by two or more carbon atoms, and preferably by two carbon atoms.

In embodiments, one or both of R⁶ and R⁷ include one or more oxygen atoms in the form of one or more hydroxyl groups. In some embodiments, one or both of R⁶ and R⁷ are of the formula: —(CR¹⁰₂)_{q}(CHOH)(CH₂)_{z}R¹¹, where R¹⁰ is independently selected from —H and alkyl, wherein q and z are independently (—) (a covalent bond), or an integer in the range of 1-12, and R¹¹ is selected from the group consisting of C1-C24 linear, branched, or cyclic alkyl, aryl, alkyl-aryl, and aryl-alkyl. Preferably q and z are independently (—), 1, or 2. Even more preferably R¹⁰ is —H; q is 1; z is (—); and R¹¹ is selected from C1-C18 linear, branched, or cyclic alkyl, aryl, alkyl-aryl, and aryl-alkyl groups. Exemplary alkyl, alkyl-aryl, and aryl-alkyl groups are described herein. Exemplary species of the formula: —(CR¹⁰₂)_{q}(CHOH)(CH₂)_{z}R¹¹, include the following groups:

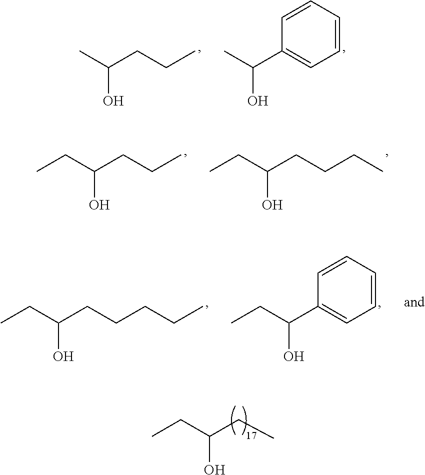

In embodiments, one or both of R⁶ and R⁷ include two or more oxygen atoms at least one in the form a hydroxyl group(s) and at least one in the form of an ether group(s). In some embodiments, one or both of R⁶ and R⁷ are of the formula: —(CR¹⁰₂)_{q}(CHOH)(R¹²O)_{z}R¹¹, where R¹⁰ is independently selected from —H and alkyl, wherein q is (—) (a covalent bond) or an integer in the range of 1-12, and R¹¹ is selected from C1-C24 linear, branched, or cyclic alkyl, aryl, alkyl-aryl, and aryl-alkyl groups, and R¹² is independently selected from —(CH₂)_{w}—, wherein w is 1, 2, or 3, and wherein z is an integer in the range of 1-100, 1-50, 1-25, 1-15, 1-10, 1-5, or t is 2, 3, or 4. In preferred aspects, R¹⁰ is —H; q is 1; z is 1; w is 1 or 2, and R¹¹ is C1-C18 linear, branched, or cyclic alkyl, aryl, alkyl-aryl, and aryl-alkyl. Exemplary alkyl, alkyl-aryl, and aryl-alkyl groups are described herein.

Exemplary species of the formula: (CR¹⁰₂)_{q}(CHOH)(R¹²O)_{z}R¹¹, include the following groups:

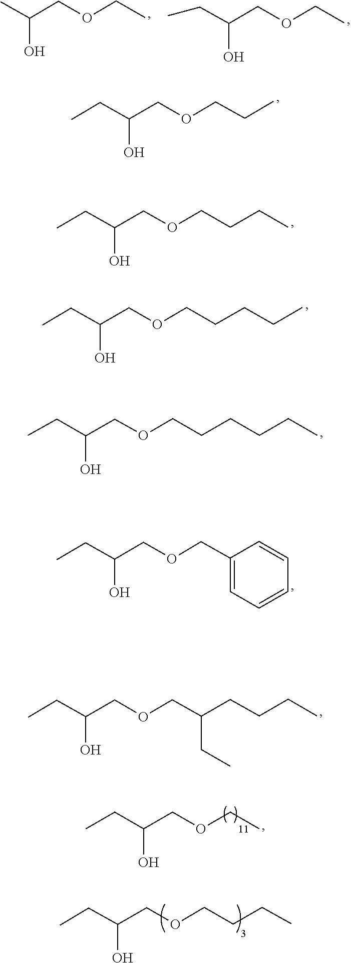

Preferred compounds of Formula I include those wherein one or more of —R¹, —R², —R³, —R⁴, and —R⁵ is —OH, and those —R¹, —R², —R³, —R⁴, and —R⁵ that are not —OH are —H. For example, some preferred compounds of the disclosure have the following sub-Formula Ia, wherein R⁶ and R⁷ have the meanings described herein.

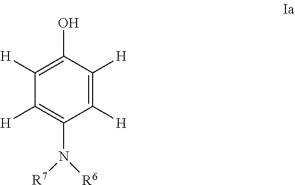

Exemplary compounds of sub-Formula Ia include, wherein both of R⁶ and R⁷ are of the formula: —(CR¹⁰₂)_{q}(CHOH)(CH₂)_{z}R¹¹, 4-bis[(2-hydroxyethyl)amino] phenol, 4-bis[(2-hydroxypropyl)amino] phenol, 4-bis[(2-hydroxybutyl)amino]phenol, 4-bis[(2-hydroxypentyl)amino]phenol, 4-bis[(2-hydroxyhexyl)amino]phenol, 4-bis[(2-hydroxy-2-phenyl)amino]phenol, 4-bis[(2-hydroxy-2-phenylethyl)amino]phenol, 4-bis[(2-hydroxyheptyl)amino]phenol, 4-bis[(2-hydroxyoctyl)amino]phenol, 4-bis[(2-hydroxynonyl)amino]phenol,4-bis[(2-hydroxydecyl)amino]phenol, 4-bis[(2-hydroxyundecyl)amino]phenol, 4-bis[(2-hydroxydodecyl)amino]phenol, 4-bis[(2-hydroxytridecyl)amino]phenol, 4-bis[(2-hydroxytetradecyl)amino]phenol, 4-bis[(2-hydroxypentadecyl)amino] phenol, 4-bis[(2-hydroxyhexadecyl)amino]phenol, 4-bis[(2-hydroxyheptadecyl)amino]phenol, 4-bis[(2-hydroxyoctadecyl)amino]phenol, 4-bis[(2-hydroxyeleyl)amino]phenol, 4-bis[(2-hydroxynonadecyl)amino]phenol, 4-bis[(2-hydroxyeicosyl)amino]phenol, 4-bis[(2-hydroxyheneicosyl)amino]phenol, 4-bis[(2-hydroxydocosyl)amino]phenol, and 4-bis[(2-hydroxytricosyl)amino]phenol.

Other exemplary compounds of sub-Formula Ia wherein both of R⁶ and R⁷ are of the formula: —(CR¹⁰₂)_{q}(CHOH)(R¹²O)_{z}R¹¹ include, but are not limited to, 4-bis[(3-methoxy-2-hydroxy-propyl)amino]phenol, 4-bis[(3-ethoxy-2-hydroxy-propyl)amino]phenol, 4-bis[(3-propoxy-2-hydroxy-propyl)amino]phenol, 4-bis[(3-butoxy-2-hydroxy-propyl)amino]phenol, 4-bis[(3-pentyloxy-2-hydroxy-propyl)amino]phenol, 4-bis[(3-hexyloxy-2-hydroxy-propyl)amino]phenol, 4-bis[(3-heptyloxy-2-hydroxy-propyl)amino]phenol, 4-bis[(3-octyloxy-2-hydroxy-propyl)amino]phenol, 4-bis[(3-nonyloxy-2-hydroxy-propyl)amino]phenol, 4-bis[(3-decyloxy-2-hydroxy-propyl)amino]phenol, 4-bis[(3-undecyloxy-2-hydroxy-propyl)amino]phenol, 4-bis[(3-dodecyloxy-2-hydroxy-propyl)amino]phenol, 4-bis[(3-tridecyloxy-2-hydroxy-propyl)amino]phenol, 4-bis[(3-tetradecyloxy-2-hydroxy-propyl)amino]phenol, 4-bis[(3-pentadecyloxy-2-hydroxy-propyl) amino]phenol, 4-bis[(3-hexadecyloxy-2-hydroxy-propyl)amino]phenol, 4-bis[(3-heptadecyloxy-2-hydroxy-propyl)amino]phenol, 4-bis[(3-octadecyloxy-2-hydroxy-propyl)amino]phenol, 4-bis[(3-eleyloxy-2-hydroxy-propyl)amino]phenol, 4-bis[(3-nonadecyloxy-2-hydroxy-propyl)amino]phenol, 4-bis[(3-eicosyloxy-2-hydroxy-propyl)amino]phenol, 4-bis[(3-heneicosyloxy-2-hydroxy-propyl)amino]phenol, 4-bis[(3-docosyloxy-2-hydroxy-propyl)amino]phenol, and 4-bis[(3-tricosyloxy-2-hydroxy-propyl)amino]phenol.

Aromatic compounds of the disclosure that can be used for synthesis of the antioxidant compounds of the disclosure include aminophenol compounds as described herein, can be prepared using methods according to the disclosure. In some modes of practice, and as a general matter, an aryl-group containing reactant having either a primary amine and a hydroxyl group, such as 4-aminophenol, is reacted with a carbon and oxygen-containing reactant, capable of reaction with the primary (and optionally secondary) amine group to provide a product, such as described herein. The carbon and oxygen-containing reactant, when reacted with the amine group can provide one or both of group(s) R⁶ and/or R⁷ which can be of the formula: —(CR¹⁰₂)_{q}(CHOH)(CH₂)_{z}R¹¹, or (CR¹⁰₂)_{q}(CHOH)(R¹²O)_{z}R¹¹

In some modes of practice, the reactant includes an oxirane group or an oxitane group as the amine-reactive group. Oxirane- and oxitane-containing reactants can include desired carbon chemistry and can also include additional oxygen atom(s), such as in the form of ether groups. Exemplary oxirane-containing reactants are glycidyl ethers, such as alkyl glycidyl ethers.

In some modes of practice, the oxirane-containing reactant is of Formula II:

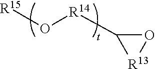

wherein R¹³ is —(CH₂)— or —(CH₂CH₂)—, wherein R¹⁴ is —(CH₂)_{w}—, wherein w is an integer in the range of 1-3, t is an integer in the range of 1-100, 1-50, 1-25, 1-15, 1-10, 1-5, or t is 1, 2, 3, or 4, and wherein R¹⁵ is R¹⁰, as described herein, optionally substituted with one or more hydroxyl groups.

In modes of preparation, the aminophenol compound as described herein can be reacted with the carbon and oxygen-containing reactant, e.g., a glycidyl ether, at a desired molar ratio. The ratio can be an equimolar ratio, or a molar ratio wherein the carbon and oxygen-containing reactant is greater than the aminophenol compound. In exemplary modes of practice, the carbon and oxygen-containing reactant is reacted at about a two-fold molar excess over the aminophenol compound.

An exemplary reaction is shown below in which 4-aminophenol is reacted with butylglycidyl ether at a 1:2 molar ratio, respectively, to provide 4-bis[(3-butoxy-2-hydroxy-propyl)amino]phenol:

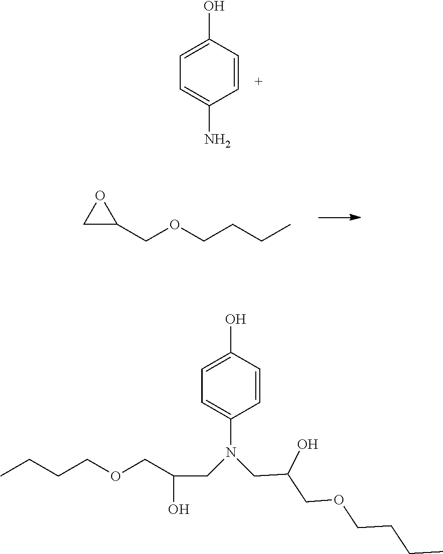

In some embodiments, the reaction product can include a mixture of oxygenated aminophenol products that include oxygenated aminophenols wherein (a) both of R⁶ and R⁷ are carbon-containing groups with one or more oxygen atoms (e.g., hydroxyl and ether such as —(CR¹⁰₂)_{q}(CHOH)(R¹²O)_{z}R¹¹) and (b) where one of R⁶ and R⁷ is a carbon-containing groups with one or more oxygen atoms (e.g., —(CR¹⁰₂)_{q}(CHOH)(R¹²O)_{z}R¹¹), and the other is —H. Such a mixture can be formed by using a glycidyl ether reactant to aminophenol at a molar ratio of greater than 1:1 but less than 2:1, respectively.

In some modes of practice, the aminophenol reactant and carbon and oxygen-containing reactant (e.g., oxirane or oxitane-containing reactant) are reacted at a temperature where one or both reactants are in the liquid phase. In some modes of practice, the oxirane/oxitane-containing reactant is in the liquid phase at the desired reaction temperature, and it solvates the aminophenol containing reactant. In this regard, the aminophenol containing reactant can have a melting point greater than the carbon and oxygen-containing reactant. In embodiments wherein the reactants are melted and/or solvated at the desired reaction temperature, any other component, such as an organic solvent otherwise typically used in reaction schemes, may be optional, and not required. Therefore, an organic solvent can be excluded from the reaction method. Further, a component such as a catalyst can also be optional, and therefore not required. In some modes of practice, the synthesis method does not include use of (a) an organic solvent, (b) a catalyst, or both (a) and (b).

Exemplary reaction temperatures can be in the range of about room temperature (˜25° C.) to about 250° C., about 40° C. to about 200° C., or about 50° C. to about 175° C.

Alternatively, the aminophenol and carbon and oxygen-containing reactants can be reacted in an organic solvent such as an alcohol like methanol, butyl carbitol, and butyl glycol, with reflux at an elevated temperature (e.g., >100° C.).

A composition that includes the oxygenated aminophenol and any one or more optional component can be in a desired form, such as in a liquid form, a dry form, or as a suspension or dispersion. The oxygenated aminophenol can be in a desired physical state in the composition, such as in a dissolved state, in a partially dissolved state, in a suspended state, or in a dry mixture. The oxygenated aminophenol can optionally be in a particulate form in the composition. If the oxygenated aminophenol is in a particulate form, the particles can optionally be described in terms of particle size (e.g., particles of a size range) and/or shape. The form of the composition and the state of the component(s) therein can be chosen by selection of the oxygenated aminophenol, with an understanding of its physical properties.

The form of the composition and the state of the component(s) therein can also be affected by the inclusion of one or more optional components, such as a solvent, or solvent mixture, or other excipient compounds that are different than the oxygenated aminophenol. The form of the composition and the state of the components therein can also be affected by temperature, and composition properties may optionally be described in circumstances at a particular temperature (e.g., at a storage temperature such as 5° C. or below, at room temperature (25° C.), or at a temperature used for the desired application.

In some embodiments, the oxygenated aminophenol is present in a “stock” composition or “concentrate”, wherein the concentrate is configured to be added to a biodiesel or biolubricant composition. The addition of the oxygenated aminophenol concentrate dilutes it to a working concentration in the biodiesel or biolubricant composition. The oxygenated aminophenol concentrate can be biodiesel or biolubricant composition that has not been previously treated with any secondary component(s) (e.g., performing-enhancing components), or can be added to a biodiesel or biolubricant composition previously treated with one or more secondary component(s). The oxygenated aminophenol can even be added to a biodiesel or biolubricant composition previously treated with an antioxidant that is different than the oxygenated aminophenol antioxidant of the disclosure.

A stock composition of an oxygenated aminophenol can be dissolved in a solvent to a concentration of about at least about 0.00001% (wt), at least about 1% (wt), at least about 5% (wt) such as in an amount in the range of about 0.00001% (wt) to about 50% (wt), an amount in the range of about 1% (wt) to about 50% (wt), or an amount in the range of about 5% (wt) to about 50% (wt).

A concentrate including the oxygenated aminophenol can be present in a composition with a solvent, or a combination of solvents. A solvent or solvent combination can be chosen so that the oxygenated aminophenol is soluble in the solvent or solvent combination. Useful solvents include any solvent in which the oxygenated aminophenol is soluble or can be stably suspended. In some embodiments, a solvent or solvent combination can be selected from water soluble or water miscible solvents such glycol-based solvents and hydrophobic or hydrocarbon solvents such as aromatic solvents, paraffinic solvents, or mixtures of both.

Exemplary glycol solvents include, but are not limited to, C₁-C₈ glycols such as ethylene glycol, propylene glycol, diethylene glycol, and triethylene glycol, ethers of such glycols such as diethylene glycol monobutyl ether, diethylene glycol monomethyl ether, diethylene glycol monoethyl ether, diethylene glycol monobutyl ether, triethylene glycol, triethylene glycol monomethyl ether, liquid polyethylene glycol, dipropylene glycol, dipropylene glycol monomethyl ether, dipropylene glycol monoethyl ether, and a low molecular weight polypropylene glycol and the like and combinations thereof. Commercial solvents such as Butyl Carbitol and Butyl CELLOSOLVE™, which contains primarily Butyl CARBITOL™, which consists primarily of ethylene glycol monobutyl ether may be used and are available from DOW.

Other exemplary hydrophobic or hydrocarbon solvents include heavy aromatic naphtha, toluene, ethylbenzene, isomeric hexanes, benzene, xylene, such as ortho-xylene, para-xylene, or meta-xylene, and mixtures of two or more thereof.

In some embodiments, the solvent is selected from glycol and aromatic naphtha and combinations thereof.

A concentrate including the oxygenated aminophenol can further optionally include one or more additional components, such as additives, that could be beneficial for use in a biodiesel or biolubricants composition at a working concentration. These optional additive components can include, for example, dispersants or detergents, de-emulsifiers, defoamers, etc., as described herein. In a concentrate, the one or more optional additives can also be at a high concentration along with the oxygenated aminophenol antioxidant, so that when the concentrate is diluted these components are provided at working concentrations (e.g., ppm).

In some embodiments the oxygenated aminophenol antioxidant is used in a vegetable or animal oil or fat composition, or in a composition including derivatives thereof. The aminophenol antioxidant can also be in a food or foodstuff composition that also includes the vegetable or animal oil or fat. In some cases, the aminophenol antioxidant can be directly used in a pure (neat) vegetable or animal oil or fat composition. In other cases, the aminophenol antioxidant becomes present in a food or foodstuff composition because it is first present in a vegetable or animal oil.

Vegetable oils and fats are commonly extracted from seeds or other parts of vegetables and fruits. For example, common vegetable oils include palm oil, soybean oil, rapeseed oil, sesame oil, sunflower oil, grape seed oil, olive oil, and cottonseed oil. Common animal oils include fish oil, and fat from animals such as pigs and chickens. Vegetable oils and fats generally include mixtures of triglycerides. The oxygenated aminophenol antioxidant can be directly added to any type of vegetable or animal oil composition, either refined or unrefined, to provide antioxidant activity and hinder oxidation of oil components therein.

Vegetable oils can be partially or completely hydrogenated to provide oil derivative products that have higher melting points. Hydrogenation of vegetable oil generally involves sparging the oil at high temperature and pressure with hydrogen in the presence of a catalyst. An example of a hydrogenated oil product is vegetable shortening which has properties of a solid at room temperature. The oxygenated aminophenol antioxidant can be directly added to the oil before hydrogenation, or can be added after the hydrogenation is carried out.

Vegetable or animal oils that include the oxygenated aminophenol antioxidant of the disclosure can also be used to make a composition or article that is not intended for ingestion. For example, vegetable oils stabilized with the oxygenated aminophenol antioxidant can be used to make personal care or cosmetic products such as soaps, skin products, and perfumes. Vegetable oils including the antioxidant can also be used to make candles, and other burnable articles or compositions that can provide heat, light, or scent. Vegetable oils the antioxidant can also be used as drying oils, or can be used for varnish or paint compositions. Stabilized vegetable oils can be used to make wood treatment compositions, can be used in alkyd resin production. Vegetable oils, which are non-toxic and biodegradable, can also be used in electrical insulators, and can benefit from the oxygenated aminophenol antioxidant to improve their stability.

Vegetable oil can also be used for forming biodegradable hydraulic fluid. Hydraulic fluids are generally used in various machines to transmit power to the moving parts of these machines. Hydraulic fluids are used in various types of heavy equipment, such as for excavating and construction, cargo and human transportation, and military machinery. Examples include, but are not limited to, bulldozers, tractors, excavators, forklifts, cranes, trucks, planes, and ships. Suitable hydraulics should be able to facilitate power transmission with minimum loss, prevent corrosion of metal surfaces, and lubrication of surfaces the move against each other. Vegetable oils are often used with additives to provide desired properties to the fluid composition.

The oxygenated aminophenol antioxidant can be added to a biodiesel composition, which can be a refined or distilled biodiesel composition, a crude biodiesel composition, or a biodiesel composition that has both crude and refined components.

The oxygenated aminophenol antioxidant can be added to a biodiesel composition, which is typically prepared by the esterification of animal and/or vegetable oils. For example, some vegetable oils that are used for preparation of biodiesel include palm oil, soybean oil, rapeseed oil, sesame oil, sunflower oil, grape seed oil, olive oil, and cottonseed oil. Some animal oils that are used for preparation of biodiesel include selected from fish oil, and fat from animals such as pigs and chickens. Any of these oils, fats, or any combination of thereof, can be subject to a transesterification process which reacts the oils, such as triglycerides, with a monohydric alcohol, such as methanol, ethanol, propanol, butanol, under basic catalysis to generate fatty acid alkyl esters (FAAEs). Most often methanol is reacted with the oils to generate fatty acid methyl esters (FAMEs). Upon transesterification, the viscosity of the composition is reduced as FAMEs have a lower viscosity as compared triglyceride staring material (oils and/or fats). In some cases, prior to transesterification, crude vegetable oil can be subjected to degumming, neutralization, and bleaching to prepare “straight vegetable oil” (SVO). Use of SVO as a starting oil material can be desirable as it removes materials such as gums, soaps, and other impurities that may otherwise find their way into biodiesel preparations.

Regarding viscosity, the viscosity values of vegetable oils have been reported to vary between 27.2 and 53.6 mm2/s, whereas the viscosity of vegetable oil methyl esters vary between 3.59 and 4.63 mm2/s (M. Acaroglu & A. Demirbas (2007) Relationships between Viscosity and Density Measurements of Biodiesel Fuels, Energy Sources, Part A: Recovery, Utilization, and Environmental Effects, 29:8, 705-712, DOI: 10.1080/00908310500280827). Crude biodiesel may have a mixture of FAMEs and unreacted triglycerides and therefore may have a viscosity between these two ranges.

In some embodiments, the aminophenol antioxidant is added to a crude biodiesel composition. This can be of particular use to prevent oxidation in the crude composition before it can be refined. For example, the aminophenol antioxidant is added to a crude biodiesel composition, which is then stored for a period of time and/or transported. During the storage and/or transport, oxidation of the formed fatty acid esters can be prevented which is in turn beneficial for a subsequent reefing process.

In the transesterification process, FAMEs are formed as well as reaction byproducts of glycerin and residual soaps. As mentioned, unreacted triglycerides may also be present in the crude biodiesel. The crude biodiesel can be distilled to remove glycerin and excess alcohols, and then water can be used to treat the crude biodiesel to remove residual soaps. Further, the crude biodiesel may be then filtered using a powder such as magnesium silicate, to produce a refined (final) biodiesel product. in some modes of practice, the aminophenol antioxidant can be added to a crude biodiesel composition prior to it being refined. The aminophenol antioxidant can stay with the FAMEs during the refining process and therefore remain in a purified biodiesel composition.

Crude and refined biodiesel can include fully saturated, monounsaturated-, di-unsaturated-, and/or tri-unsaturated fatty acid methyl esters of having 8-22 carbon atoms, which, as noted herein, are derived from vegetable and/or animal sources. Specific chemical species that may be found in crude and refined biodiesel include caprylic acid methyl ester, capric acidmethyl ester, lauric acid methyl ester, myristic acid methyl ester, lauroleic acid methyl ester, myristoleic acid methyl ester, palmitoleic acid methyl ester, palmitic acid methyl ester, methyl stearate (n-octadecanoic acid, methyl ester), methyl oleate (9-octadecenoic acid, methyl ester), methyl vaccenate (11-octadecenoic acid methyl ester), methyl linoleate (9,12-octadecadienoic acid, methyl ester), methyl linoleniate (9,12,15- octadecatrienoic acid, methyl ester), 1 elaidic acid methyl ester, arachidic acid methyl ester, gadoleic acid methyl ester, arachidonic acid methyl ester, erucic acid methyl ester, and behenic acid methyl ester.

In embodiments, the predominant fatty acid methyl esters in the crude or refined biodiesel are selected from the group consisting of palmitoleic acid methyl ester, palmitic acid methyl ester, methyl stearate (n-octadecanoic acid, methyl ester), methyl oleate (9-octadecenoic acid, methyl ester), methyl vaccenate (11-octadecenoic acid methyl ester), methyl linoleate (9,12-octadecadienoic acid, methyl ester), methyl linoleniate (9,12, 15- octadecatrienoic acid, methyl ester), lelaidic acid methyl ester, arachidic acid methyl ester, gadoleic acid methyl ester, arachidonic acid methyl ester, and erucic acid methyl ester, which are C16 saturated and partially unsaturated, and C16 saturated and partially unsaturated, fatty acid methyl esters. “Predominant” means that the one fatty acid methyl ester, or more typically multiple fatty acid methyl esters, constitute more than 50% by weight of the total fatty acid methyl esters in the biodiesel composition. In embodiments, more than 60% by weight, more than 70% by weight, more than 80% by weight, more than 90% by weight, or more than 95% by weight of fatty acid methyl ester in the biodiesel composition are selected from C16 and C18 saturated and partially unsaturated fatty acid methyl esters.

Biodiesel fuels can optionally be described in terms of iodine number, which reflects the amount of unsaturated fatty acids esters in the composition, and the ease at which the oil oxidizes when exposed to air. Generally, iodine values for biodiesel are typically in the range of 60-150, and more typically 80-135. A higher iodine value indicates that the fatty acid ester has more unsaturated carbon-carbon bonds. Iodine value can be determine using standards such as DIN 53241-1. The iodine number can be determined for a biodiesel composition that includes the oxygenated aminophenol antioxidant of the disclosure versus one that does not include an antioxidant, or can be compared to a different antioxidant, after a defined period of storage. In some embodiments, biodiesel fuels that including the oxygenated aminophenol antioxidant have an iodine number of not greater than 125, not greater than 100, or not greater than 75.

Biodiesel fuels can optionally be described in terms of cetane number or cetane rating, which is a number that indicates the fuel's combustion speed and compression needed for ignition. Cetane ratings range from 15 (longest combustion delay) to 100 (shortest combustion delay). Diesel fuels typically have a cetane rating in the range of about 45 to about 65, with biodiesel fuels more specifically having a cetane rating in the range of about 48 to about 65. The cetane rating can be determined for a biodiesel composition that includes the oxygenated aminophenol antioxidant of the disclosure versus one that does not include an antioxidant, or can be compared to a different antioxidant.

Biodiesel fuels can optionally be described in terms of energy content, such as specific energy (energy per unit mass of the biodiesel), or energy density, (energy per unit volume of the biodiesel). While biodiesel is denser, it has less specific energy than petrodiesel. For example, per unit volume, biodiesel will have about 93% of the energy as compared to petrodiesel. Measurements of energy content are typically expressed in terms of megajoules per kilogram (MJ/kg) (specific mass), or British thermal units per gallon (BTU/gal) (energy density). Exemplary energy densities for biodiesel are in the range of about 119,550 Btu/gal B20 126,700 Btu/gal (c)(B100=100% biodiesel) (for example, see: afdc.energy.gov/fuels/properties). An average specific energy of biodiesel is about 37.8 MJ/kg. The energy content can be determined for a biodiesel composition that includes the oxygenated aminophenol antioxidant of the disclosure versus one that does not include an antioxidant, or can be compared to a different antioxidant.

Biodiesel fuels can optionally be described in terms of cold flow properties. Cold flow properties of biodiesel can be characterized my measurements including one or more of pour point (PP), cloud point (CP), and cold filter plugging point (CFPP). Cloud point can be measured by standards such as ASTM D2500 (2005), which determines the temperature at which observable crystals are formed. The lowest flowable temperature, or lowest pumpable temperature, of a biodiesel is referred to its pour point (PP). CFPP test for the highest temperature at which the biodiesel can pass through a standardized filter. A common method to evaluate pour point (PP) is according to ASTM D97, and a common method to evaluate filterability limit via cold filter plugging point (CFPP) is according to DIN EN 116 or ASTM D6371.

The FAME content can affect the cold flow properties of a biodiesel feedstock. The lower the carbon number and the lower the degree of saturation is in the fatty acid chains, the better is the cold flow property of the feedstock.

PP, CP, and CFPP can be determined for a biodiesel composition that includes the oxygenated aminophenol antioxidant of the disclosure versus one that does not include an antioxidant, or can be compared to a different antioxidant.

In some embodiments biodiesel compositions with the oxygenated aminophenol antioxidant of the disclosure have a pour point (PP) value of less than 0° C., less than −5.0° C., or less than −10.0° C. In some embodiments biodiesel compositions with the oxygenated aminophenol antioxidant of the disclosure have a cloud point (CP) value of less than 0° C., less than −5.0° C., or less than −10.0° C.

Biodiesel compositions with the oxygenated aminophenol antioxidant of the disclosure biodiesel compositions. In addition, the viscosity can be varied by the amount and the molecular weight of the ester-comprising polymers used. The kinematic viscosity of preferred fuel compositions of the present invention is in the range of 1 to 10 mm2/s, more preferably 2 to 5 mm2/s and especially preferably 2.5 to 4.5 mm2/s, measured at 40° C. to ASTM D445.

Biodiesel fuels can optionally be described in terms of sulfur content. Generally, biodiesel fuels have a low sulfur content, such as about 50 ppm or less, 25 ppm or less, 15 ppm or less, 10 ppm or less, or 5 ppm or less sulfur. Advantageously, the use of the oxygenated aminophenol antioxidant does not add to the sulfur content of the biodiesel composition.

Other measurements of diesel fuel's quality include (but are not limited to) energy content, density, lubricity, cold-flow properties and sulfur content.

Biodiesel fuels can optionally be described in terms of flash point. Generally, biodiesel fuels have a flashpoint in the range of about 100° C. to about 170° C., such as about 130° C. Use of the oxygenated aminophenol antioxidant should not adversely affect the flash point of the treated biodiesel composition.

Biodiesel compositions that include the oxygenated aminophenol antioxidant of the disclosure can be used as neat biodiesel, or alternatively be blended with petrodiesel. A diesel blend including part biodiesel and part petrodiesel can be formulated to provide certain performance properties depending on how the diesel is intended to be used. In embodiments, the disclosure provides blended diesel compositions including the oxygenated aminophenol antioxidant, wherein greater than 50% (wt), 60% (wt) or greater, 70% (wt) or greater, 80% (wt) or greater, 90% (wt) or greater, or 95% (wt) or greater of the diesel is from biodiesel.

Crude biodiesel and/or the refined biodiesel may also be subjected to processing which reduces unsaturation in the fatty acid portions of the formed methyl esters.

Distilled or refined biodiesel is formed crude biodiesel that has been subjected to at least one processing step to remove undesired components, such as excess alcohols, residual glycerin, and other impurities. For example, the biodiesel can be obtained as a particular fraction produced during the distillation of crude biodiesel.

Biodiesel fuels of the disclosure may optionally be described with reference to a boiling point, such as one in the range of 120° C. to 450° C., or 170° C. to 390° C. The biodiesel fuel can be from a middle distillate having low sulfur (e.g., less than 100 ppm, less than 50 ppm, or even less than 10 ppm).

An amount of the oxygenated aminophenol antioxidant, and any other (optional) component in the biodiesel or biolubricant composition can be described in various ways, such as by a weight percentage (% wt.), by parts per amount, or by molar amount of oxygenated aminophenol in the biodiesel or biolubricant composition. When other components are used along with the oxygenated aminophenol in the biodiesel or biolubricant composition, such compounds can also be described in terms of weight ratios, or in terms of relative amounts to one another, in a composition.

In some embodiments, the concentration of oxygenated aminophenol antioxidant in the biodiesel fuel is about 1 ppm or greater, 5 ppm or greater, 25 ppm or greater, or 50 ppm or greater, and up to about 5000 ppm, up to about 2500 ppm, up to about 1500 ppm, up to about 1000 ppm, up to about 750 ppm, or up to about 500 ppm, or in the range of any of these lower and upper concentrations. For example, the oxygenated aminophenol antioxidant is used in the range of about 1 ppm to about 5000 ppm, about 5 ppm to about 1500 ppm, about 25 ppm to about 1000 ppm or about 50 ppm to about 750 ppm.

If other additive components are used in the biodiesel composition along with the oxygenated aminophenol antioxidant, such compounds can also be described in terms of percent weight, or ppm, of the total composition, or in term of molarity, weight ratios, or in terms of relative amounts to one another in the biodiesel composition.

Optionally, the biodiesel composition can include one or more further additive(s) in addition to the oxygenated aminophenol antioxidant to provide a fuel with desired specifications and performance. Exemplary optional additives include corrosion inhibitors, dispersants or detergents, de-emulsifiers, defoamers, cetane number improvers, detergents, dyes, metal deactivators, metal passivators, biocides, and odorants or odor masks. Any one or more of these additives can be used in the biodiesel or biolubricant composition of the disclosure, along with the oxygenated aminophenol antioxidant, at conventional concentrations known in the art.

Optional corrosion inhibitors that can be added to a biodiesel or biolubricants composition of the disclosure include compounds such as dodecylsuccinic acid esters or amides, phosphate esters, alkyl imidazolines, sarcosines, n-butylamine (BA), ethylenediamine (EDA), tetra-butylamine (TBA), steric acid, beta-carotene, and propyl gallate. (See, for example, see, Tabish, A. (2018), Corrosion Behaviour of Biofuel, Petro. Chem. Indus. Intern., 1:1-19; and Rudnick, L. R. (2003) Lubricant Additives: Chemistry and Applications,” New York, Marcel Dekker, Ch. 5, 137-170). Through its function as an antioxidant, the aminophenol of the disclosure can indirectly provide corrosion inhibition, by minimizing the formation of compounds that may otherwise promote corrosion. Optionally, one or more dispersant(s) can be added to the biodiesel or biolubricant composition of the disclosure, along with the oxygenated aminophenol antioxidant. Exemplary dispersants include compounds such as hydrocarbyl-substituted succinimides, lecithin surfactants, succinate esters, pentaerythritols, phenate-salicylates, and other surfactant-type compounds. If present in a biodiesel or a biolubricant composition, a dispersant can be used in an amount in the range of about 0.01 wt. % to about 10 wt. %. See, for example, US20110283603A1, US20150152358A1, U.S. Pat. No. 7,960,322B2, and Rudnick, L. R. (2003) Lubricant Additives: Chemistry and Applications,” New York, Marcel Dekker, Ch. 5, 137-170.

Optionally, one or more de-emulsifier(s) can be added to the biodiesel or biolubricant composition of the disclosure, along with the oxygenated aminophenol antioxidant. A de-emulsifier can facilitate the separation of water from oil in the biodiesel or biolubricant compositions, which be contacted with water or steam. Exemplary de-emulsifier include polyalkylene oxides such as polyethylene oxide, polypropylene oxide, and copolymers thereof, polyoxyethylene sorbitan ester, anionic surfactants such as alkyl-naphthalene sulfonates and alkyl benzene sulfonates, nonionic alkoxylated alkylphenol resins. If present in a biodiesel or a biolubricant composition, a de-emulsifier can be used in an amount in the range of about 0.01 wt. % to about 10 wt. %.

Optionally, one or more defoamer(s) or anti-foam agents can be added to the biodiesel or biolubricant composition of the disclosure, along with the oxygenated aminophenol antioxidant. Various types of anti-foam agents are known and that can be optionally be used to control any form in the compositions of the disclosure. Examples include, but are not limited to silicone-based anti-foam agents such as polydimethylsiloxanes, halogentated silicones, and silicone oils. Other anti-foam agents include polyethers such a polypropylene glycol (PPG) and polyethylene glycols (PEG), alkylated (meth)acrylate polymers, polyvinyl ethers, and polyalkoxyamines. If present in a biodiesel or a biolubricant composition, a de-emulsifier can be used in an amount in the range of about 0.01 wt. % to about 5 wt. %.

In some embodiments of the method, the aminophenol antioxidant inhibits oxidation of the ester or the oil at a level greater than 1.4×, greater than 1.5×, greater than 1.6×, greater than 1.7×, greater than 1.8×, greater than 1.9×, or greater than 2.0×, up to about 2.2×, than the level of oxidation in the absence of the oxygenated aminophenol antioxidant.

In embodiments the composition that includes the ester of a vegetable-derived fatty acid, or a vegetable-derived oil, and the oxygenated aminophenol antioxidant, is a lubricity composition. The lubricity composition can be similar to, or even identical to a biodiesel fuel composition that includes the oxygenated aminophenol. In addition to being useful as a combustible material, fatty acid alkyl esters are known enhance lubricity of composition in which they are included. Their functionality as a lubricity agent can be due to the presence of an alkyl (e.g., methyl) ester chemical group, as well as unsaturated carbon-carbon bonds (C═C) that increase polarity of the compound, which can promote adherence to a surface, such as a metal surface.

A biolubricant composition that includes a vegetable-derived alkyl ester fatty acid and the oxygenated aminophenol antioxidant of the disclosure can be added to any fuel type to improve lubricity properties. In some embodiments the biolubricant composition is added to a fuel such as gasoline, kerosene, aviation fuel, light oil, or alkanol fuels. A biolubricant composition can also be added to alternative fuel that has poor lubricity properties, such dimethyl ether (DME), gas-to-liquid (GTL) fuel derived from natural gas, coal-to-liquid (GTL) fuel derived from natural gas. A mixture of the alternative fuel and the biolubricant composition with antioxidant can be used to prevent friction and wear in engines that use these alternative fuels. In turn this can extend the stability and performance of vehicles that use these biolubricant materials.

In embodiments, the biolubricant composition is mixed with a fuel in an amount of about 0.0001% (wt) or greater, 0.001% (wt) or greater, 0.01% (wt) or greater, or 0.1% (wt) or greater, and up to about 10% (wt), 5% (wt), or 1% (wt), or in a range of any of these lower and upper values as endpoints.

The biolubricant composition can also be used as a lubricating oil in neat form, or can be mixed with a lubricating oil (e.g., a lubricating oil derived from a petroleum product) at any desired ratio.

The biolubricant compositions of the disclosure can reduce the friction generated between two mechanical surfaces as caused by the movement of at least one of the surfaces relative to the other. In turn, the biolubricant compositions can extend the lifespan of a machine having such moving parts, such as a high-pressure ignition-type diesel engine.

Triglycerides from vegetable oils and animal fats can also be used to produce straight chain alkane (C8 to C18) hydrocarbon compositions, which are particularly useful for making aviation fuels. Methods that can be used for making these hydrocarbon compositions include hydrodeoxygenation of triglycerides or free fatty acids. Another method is the decarboxylation of fatty acids without using hydrogen over heterogeneous noble metal catalysts. Noble metals such as Pd and Pt have been used to catalyze the decarboxylation of fatty acids and their derivatives. (E.g., see Fu, J., et al. (2010) Catalytic hydrothermal deoxygenation of palmitic acid. Energy Environ Sci. 3:311-317). Decarboxylation of fatty acids over non-noble metal catalysts without added hydrogen can also be performed in the presences of Ni/C catalysts (e.g., see Wu, J., et al. (2016) Catalytic Decarboxylation of Fatty Acids to Aviation Fuels over Nickel Supported on Activated Carbon. Sci Rep 6, 27820).

In embodiments, the ability of the oxygenated aminophenol antioxidant to function as an antioxidant and provide stability to a composition including an ester of a vegetable- or animal-derived fatty acid, or a vegetable- or animal-derived oil, can be described in terms of an oxidation stability test. A commonly used oxidation stability test is the Rancimat test (e.g., Standard Test Method EN 14112), which measures the conductivity of volatile organic compounds formed as degradation products from the oxidation oxidizable components of an oil or oil derivative composition, such as fatty acid methyl esters. Tests are conducted under conditions that promote oxidation (introduced air and heat), and measured over a period of time until appearance the secondary reaction products, which changes the conductivity, and signals the “induction point.” Under the test conditions the time from the start of the test to the induction point is referred to as the “induction time” or “induction period.” For example, as described in the appended examples, the Rancimat test conducted is according to Standard Test Method EN 14112, using an air stream that is passed through 7.5 g of a sample of the oil or fatty acid methyl ester composition, at a temperature of 110° ° C. and at an airflow of 10 L/h. The ability of an antioxidant to prolong the induction period can be measured and compared to a control, such as an oil composition that includes no antioxidant, or an oil composition that includes a comparative antioxidant.

As reflected in the examples, induction periods for fatty acid methyl ester (FAME) compositions from various sources ranged from about 2.87 hours to about 6.71 hours. The difference in inductions times can be due to the relative amounts of oxidizable compounds in the FAME compositions, or secondary components that either promote or hinder the oxidation reaction. Nonetheless, the ability of an antioxidant to prolong the induction period can be expressed in terms of a percent increase in induction time as compared to a control (e.g., a composition without an antioxidant, or a composition with a comparative antioxidant).

In some embodiments, the oxygenated aminophenol antioxidant can prolong the induction time for a period of time that is greater than 50% as compared to the induction time without an antioxidant, for a period of time that is greater than 60%, for a period of time that is greater than 60%, for a period of time that is greater than 70%, for a period of time that is greater than 80%, for a period of time that is greater than 90%, for a period of time that is greater than 1000%, or for a period of time that is greater than 110% of the induction time without an antioxidant, and up to 275%, up to 250%, up to 225%, up to 200%, up to 175%, up to 160%, up to 150%, up to 140%, up to 130%, or up to 125% as compared to the induction time without an antioxidant. For example, an oxygenated aminophenol antioxidant of the disclosure that prolongs the induction time by 75% relative to a control composition without antioxidant that otherwise provides an induction time of 3 hours, would have an induction time of 5.25 hours (i.e., 1.75×3=5.25).

Use of the oxygenated aminophenol antioxidant typically outperformed other comparative antioxidants which generally showed induction times that were generally less than 50% greater than the induction time of an oil composition without an antioxidant.

### Examples

### Example 1: Synthesis of AO-1 (4-Aminophenol-Butylglycidyl Ether Adduct)

With reference to the components and amounts thereof in Table 1, to a 250 mL three necked round-bottom flask equipped with temperature probe, nitrogen inlet, condenser and magnetic stir bar was added butylglycidyl ether. 4-Aminophenol was then added to the well-stirred reaction mixture. The resulting suspension was heated to 120° ° C. under nitrogen blanket and stirred for 8 h or until completion of reaction. As reaction proceeded to completion, suspension got converted to a homogenous dark-amber product. The resulting product was characterized by NMR and ESI-MS.

TABLE 1

| | | | Amount | | Mole |
|---|---|---|---|---|---|
| | MW(g/mol) | Purity | (g) | n(moles) | ratio |
| 4-Aminophenol | 109.12 | 98% | 20 | 0.179619 | 1 |
| BGE | 130.18 | 95% | 49.2 | 0.359041 | 2.00 |

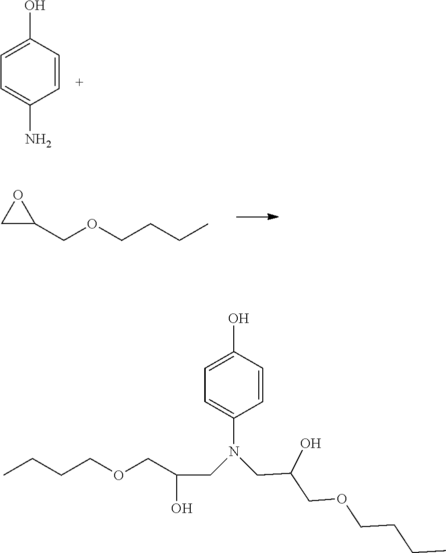

### Example 2: Synthesis of AO-2 (4-Aminophenol-2-Ethylhexylglycidyl Ether Adduct)

AO-2 was synthesized by replacing butylglycidyl ether with 2-ethylhexylglycidyl ether (EHGE) and following procedure described according to Example 1, using amounts of reactants that provided a mole ratio of 4-aminophenol to EHGE of 1:2, respectively.

### Example 3: Oxidation Stability Testing of Fatty Acid Methyl Ester with Various Antioxidants

The oxidation stability of fatty acid methyl ester composition #1 (Cargill) was tested in the presence of various antioxidants by the Rancimat test, which measures the conductivity of volatile organic compounds formed as degradation products from the oxidation of fatty acid methyl esters. Highly volatile secondary oxidation products, that are mainly formic acid, are transferred to the measuring vessel with the airflow, where they are absorbed into the measuring solution (distilled water). Conductivity is then continuously recorded, with the appearance of organic acids detected by increasing conductivity. The time that passes until appearance of these secondary reaction products is called induction time or induction period, which indicates oxidation stability, and characterizes the resistance of fats and oils to oxidation. The Rancimat test conducted is according to Standard Test Method EN 14112, which is the most widely used and accepted test for the oxidation stability of biodiesel (B100). Briefly, an air stream was passed through 7.5 g of a sample of the fatty acid methyl ester composition #1 having different antioxidants at concentrations of either 500 ppm or 1000 ppm, at a temperature of 110° C. and at an airflow of 10 L/h. Results of the test and the induction period times (measured in hours) are shown in Table 2.

TABLE 2

| Antioxidant | Conc. (ppm) | Induction period (h) |
|---|---|---|
| Blank (No AO) | 0 | 3.98 |
| Irganox ® L-135 | 1000 | 4.56 |
| 2,6-di-tert-butylphenol | 1000 | 5.76 |
| AO-1 | 1000 | 8.69 |
| AO-1 | 500 | 6.85 |
| AO-2 | 1000 | 7.57 |
| AO-2 | 500 | 6.20 |

According to the data, the FAME (Cargill) had a Rancimat oxidative stability (IP, measured in accordance with EN 14112) of 3.98 h. While the tert-butyl-containing antioxidants Irganox® L-135 (C7-9-alkyl 3-(3,5-di-tert-butyl-4-hydroxyphenyl)propionate) and 2,6-di-tert-butylphenol used at 1000 ppm, increased the induction time to 4.56 and 5.76 hours, respectively a significant increase in induction time was observed when the oxygenated aminophenol compounds AO-1 and AO-2 were used at 1000 ppm. Further, even when the concentrations of AO-1 and AO-2 were reduced to 500 ppm, they still performed better than the Irganox® L-135 and 2,6-di-tert-butylphenol antioxidants used at twice the concentration. When used at 1000 ppm, the AO-1 and AO-2 antioxidants prolonged the induction time by 118% (2.18×) and 90% (1.90×), respectively, relative to the induction time without an antioxidant.

### Example 4: Oxidation Stability Testing of Fatty Acid Methyl Ester with Various Antioxidants

The oxidation stability of fatty acid methyl ester composition #2 (SUNCOR) was tested in the presence of the Irganox® L-135 and AO-2 antioxidants using the method described in Example 3. Similar to the method of Example 3, an air stream was passed through 7.5 g of a sample of the fatty acid methyl ester and the antioxidants at concentrations of 1000 ppm, at a temperature of 110° C. and at an airflow of 10 L/h

TABLE 3

| Antioxidant | Conc. (ppm) | Induction period (h) |
|---|---|---|
| Blank (No AO) | 0 | 6.71 |
| Irganox ® L-135 | 1000 | 10.36 |
| AO-2 | 1000 | 13.99 |

Results of Example 4 show that using a different fatty acid methyl ester composition, the oxygenated aminophenol AO-2 of the disclosure provided an antioxidant effect that was greater than the comparative antioxidant Irganox® L-135. When used at 1000 ppm, the AO-1 antioxidant prolonged the induction time by 108% (2.08×) relative to the induction time without an antioxidant.

### Example 5: Oxidation Stability Testing of Fatty Acid Methyl Ester with Various Antioxidants

The oxidation stability of fatty acid methyl ester composition #3 (PLACID) was tested in the presence of the and AO-1 and AO-2 antioxidants at different concentrations using the method described in Example 3. Similar to the method of Example 3, an air stream was passed through 7.5 g of a sample of the fatty acid methyl ester and the antioxidants at concentrations of 250 ppm, 500 ppm, and 1000 ppm, at a temperature of 110° C. and at an airflow of 10 L/h.

TABLE 4

| Antioxidant | Conc. (ppm) | Induction period (h) |
|---|---|---|
| Blank (No AO) | 0 | 4.97 |
| AO-1 | 1000 | 9.60 |
| AO-1 | 500 | 7.85 |
| AO-2 | 1000 | 8.74 |
| AO-2 | 500 | 7.28 |
| AO-2 | 250 | 6.21 |

Results of Example 5 show that the oxygenated aminophenols AO-1 and AO-2 of the disclosure provided an antioxidant effect that was acceptable even when concentrations where reduced, particularly as revealed by the AO-2 used at 250 ppm greater than the comparative antioxidant Irganox® L-135. When used at 1000 ppm, the AO-1 and AO-2 antioxidants prolonged the induction time by 93% (1.93×) and 76% (1.76×), respectively, relative to the induction time without an antioxidant. Also, lower concentrations (500 ppm, 250 ppm) the AO-1 and AO-2 antioxidants proved effective for prolonging the induction time.

### Example 6: Oxidation Stability Testing of Fatty Acid Methyl Ester with Various Antioxidants

The oxidation stability of fatty acid methyl ester composition #4 (REG) was tested in the presence of Irganox® L-135 (a liquid octylated/butylated diphenylamine), Irganox® L-57, 2,6-di-tert-butylphenol, AO-1, and AO-2 antioxidants using the method described in Example 3. Similar to the method of Example 3, an air stream was passed through 7.5 g of a sample of the fatty acid methyl ester and the antioxidants at concentrations of 1000 ppm, at a temperature of 110° C. and at an airflow of 10 L/h.

TABLE 5

| Antioxidant | Conc. (ppm) | Induction period (h) |
|---|---|---|
| Blank (No AO) | 0 | 3.87 |
| Irganox ® L-135 | 1000 | 12.20 |
| Irganox ® L-57 | 1000 | 4.00 |
| 2,6-di-tert-butylphenol | 1000 | 10.92 |
| AO-1 | 1000 | 14.19 |
| AO-2 | 1000 | 12.20 |

Results of Example 6 show that using a different fatty acid methyl ester composition, the oxygenated aminophenols AO-1 and AO-2 of the disclosure provided an antioxidant effect that was greater than the comparative antioxidants Irganox® L-57, and Irganox® L-135, and 2,6-di-tert-butylphenol. These results also show the oxygenated aminophenols AO-1 and AO-2 provided superior antioxidant activity over the nitrogen-containing Irganox® L-57 antioxidant.

When used at 1000 ppm, the AO-1 and AO-2 antioxidants prolonged the induction time by 266% (3.66×) and 215% (3.15×), respectively, relative to the induction time without an antioxidant.

### Example 7: Oxidation Stability Testing of Fatty Acid Methyl Ester with Various Antioxidants at 120° ° C.

The oxidation stability of fatty acid methyl ester composition #1 (Cargill) was tested in the presence of Irganox® L-135, Irganox® L-57, AO-1, and AO-2, antioxidants at concentrations of 1000 ppm using the method described in Example 3, with the exception that the temperature of the sample was set at 120° C.

TABLE 6

| Antioxidant | Conc. (ppm) | Induction period (h) |
|---|---|---|
| Blank (No AO) | 0 | 2.87 |
| Irganox ® L-135 | 1000 | 3.43 |
| Irganox ® L-57 | 1000 | 4.00 |
| 2,6-di-tert-butylphenol | 1000 | 3.09 |
| AO-2 | 1000 | 5.57 |

Results of Example 7 show that the oxygenated aminophenol AO-2 of the disclosure still provided an antioxidant effect that was greater than the comparative antioxidants Irganox® L-57, and Irganox® L-135, and 2,6-di-tert-butylphenol at elevated temperatures. When used at 1000 ppm, the AO-2 antioxidant prolonged the induction time by 94% (1.94×) relative to the induction time without an antioxidant.

What is claimed is:

1. A composition comprising
(ai) an ester of a vegetable- or animal-derived fatty acid, (aii) a vegetable- or animal-derived oil, or both (ai) and (aii);
(b) an aminophenol antioxidant of Formula I 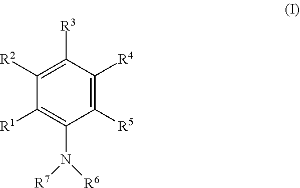
wherein —R¹, —R², —R³, —R⁴, and —R⁵ are independently selected from —H,
—OH, alkyl, aryl, alkyl aryl and aryl alkyl, and —NR⁸R⁹, wherein R⁸ and R⁹ are independently selected from —H, alkyl, aryl, alkyl aryl and aryl alkyl, and R⁶/R⁷ as described herein, or any two adjacent groups of —R¹, —R², —R³, —R⁴, and —R⁵ form one or more ring structures wherein at least one of —R¹, —R², —R³, —R⁴, and —R⁵ is —OH;
wherein one or both of R⁶ and R⁷ is or are (i) a carbon-containing group including (I) one or more hydroxyl group(s), (II) one or more ether groups, or both (I) and (II), separated from the N atom by one or more carbon atoms; if R⁶ or R⁷ is not (i) then it is selected from —H, alkyl, aryl, alkyl aryl and aryl alkyl.

2. The composition of claim 1 which is:
a fuel composition, optionally biodiesel, or a biolubricant;
present in a composition for ingestion, wherein the composition for ingestion is optionally a foodstuff, wherein the composition is optionally present in a cooked food product
present in a personal care or cosmetic product, optionally the personal care or cosmetic product is a soap, a skin product, or a perfume;
present in a varnish or paint compositions;
present in composition that is burned for heating, lighting, scent, or a combination thereof;
present in an electrical insulator composition; or
present in a hydraulic fluid composition.

3. The composition of claim 1 wherein the ester of the vegetable- or animal-derived fatty acid comprises (1) an ester of a vegetable- or animal-derived triglyceride, (2) an ester of a vegetable- or animal-derived free-fatty acid.

4. The composition claim 1, wherein the ester is (1) a methyl ester of a vegetable-derived triglyceride, (2) a methyl ester of a vegetable-derived free-fatty acid.

5. The composition of claim 1 wherein the ester of the vegetable-derived fatty acid is polyunsaturated.

6. The composition of claim 1 wherein the ester of the vegetable-derived fatty acid comprises carbon chains having a length in the range of 16-18 carbons.

7. The composition of claim 1 wherein the aminophenol antioxidant of Formula I is present in the composition in an amount in the range of 100 ppm to 2500 ppm, or in an amount in the range of 250 ppm to 1500 ppm.

8. The composition of claim 1 wherein the one or both of R⁶ and R⁷ is or are a carbon-containing group having a number of carbon atoms in the range of 1-24, 2-23, 2-22, 3-24, or 4-24.

9. The composition of claim 1, wherein —R³ is —OH.

10. The composition of claim 1, wherein the one or more hydroxyl group(s) are separated from the N atom by two or more carbon atoms, and optionally by two carbon atoms.

11. The composition of claim 1 wherein one or both of R⁶ and R⁷ are of the formula: —(CR¹⁰₂)_{q}(CHOH)(CH₂)_{z}R¹¹, R¹⁰ is independently selected from —H and alkyl, wherein q and z are independently (—) (a covalent bond), or an integer in the range of 1-12, preferably (—), 1, or 2, and R¹¹ is selected from the group consisting of C1-C24 linear, branched, or cyclic alkyl, aryl, alkyl-aryl, and aryl-alkyl.

12. The composition of claim 11, wherein R¹⁰ is —H; q is 1; z is (—); and R¹¹ is C1-C18 linear, branched, or cyclic alkyl, aryl, alkyl-aryl, and aryl-alkyl.

13. The composition of claim 12 wherein the compound is:
4-bis[(2-hydroxyethyl)amino]phenol, 4-bis[(2-hydroxypropyl)amino] phenol, 4-bis[(2-hydroxybutyl)amino]phenol, 4-bis[(2-hydroxypentyl)amino]phenol, 4-bis[(2-hydroxyhexyl)amino]phenol, 4-bis[(2-hydroxy-2-phenyl)amino]phenol, 4-bis[(2-hydroxy-2-phenylethyl)amino]phenol, 4-bis[(2-hydroxyheptyl)amino]phenol, 4-bis[(2-hydroxyoctyl)amino]phenol, 4-bis[(2-hydroxynonyl)amino]phenol, 4-bis[(2-hydroxydecyl)amino]phenol, 4-bis[(2-hydroxyundecyl)amino]phenol, 4-bis[(2-hydroxydodecyl)amino]phenol, 4-bis[(2-hydroxytridecyl)amino]phenol, 4-bis[(2-hydroxytetradecyl)amino]phenol, 4-bis[(2-hydroxypentadecyl)amino] phenol, 4-bis[(2-hydroxyhexadecyl)amino]phenol, 4-bis[(2-hydroxyheptadecyl)amino]phenol, 4-bis[(2-hydroxyoctadecyl)amino]phenol, 4-bis[(2-hydroxyeleyl)amino]phenol, 4-bis[(2-hydroxynonadecyl)amino]phenol, 4-bis[(2-hydroxyeicosyl)amino]phenol, 4-bis[(2-hydroxyheneicosyl)amino]phenol, 4-bis[(2-hydroxydocosyl)amino]phenol, and 4-bis[(2-hydroxytricosyl)amino]phenol.

14. The composition of claim 1, wherein one or both of R⁶ and R⁷ are of the formula: —(CR¹⁰₂)_{q}(CHOH)(R¹²O)_{z}R¹¹, R¹⁰ is independently selected from —H and alkyl, q is (—) (a covalent bond) or an integer in the range of 1-12, preferably (—), 1, or 2, R¹¹ is selected from the group consisting of C1-C24 linear, branched, or cyclic alkyl, aryl, alkyl-aryl, and aryl-alkyl, and R¹² is independently selected from —(CH₂)_{w}—, wherein w is 1, 2, or 3, and z is an integer in the range of 1-5.

15. The composition of claim 24, wherein R¹⁰ is —H; q is 1; z is 1; w is 1 or 2, and R¹¹ is C1-C18 linear, branched, or cyclic alkyl, aryl, alkyl-aryl, and aryl-alkyl.

16. The composition of claim 15, wherein the compound is selected from the group consisting of 4-bis[(3-methoxy-2-hydroxy-propyl)amino]phenol, 4-bis[(3-ethoxy-2-hydroxy-propyl)amino]phenol, 4-bis[(3-propoxy-2-hydroxy-propyl)amino]phenol, 4-bis[(3-butoxy-2-hydroxy-propyl)amino]phenol, 4-bis[(3-pentyloxy-2-hydroxy-propyl)amino]phenol, 4-bis[(3-hexyloxy-2-hydroxy-propyl)amino]phenol, 4-bis[(3-heptyloxy-2-hydroxy-propyl)amino]phenol, 4-bis[(3-octyloxy-2-hydroxy-propyl)amino]phenol, 4-bis[(3-nonyloxy-2-hydroxy-propyl)amino]phenol, 4-bis[(3-decyloxy-2-hydroxy-propyl)amino]phenol, 4-bis[(3-undecyloxy-2-hydroxy-propyl)amino]phenol, 4-bis[(3-dodecyloxy-2-hydroxy-propyl)amino]phenol, 4-bis[(3-tridecyloxy-2-hydroxy-propyl)amino]phenol, 4-bis[(3-tetradecyloxy-2-hydroxy-propyl)amino]phenol, 4-bis[(3-pentadecyloxy-2-hydroxy-propyl)amino]phenol, 4-bis[(3-hexadecyloxy-2-hydroxy-propyl)amino]phenol, 4-bis[(3-heptadecyloxy-2-hydroxy-propyl)amino]phenol, 4-bis[(3-octadecyloxy-2-hydroxy-propyl)amino]phenol, 4-bis[(3-eleyloxy-2-hydroxy-propyl)amino]phenol, 4-bis[(3-nonadecyloxy-2-hydroxy-propyl)amino]phenol, 4-bis[(3-eicosyloxy-2-hydroxy-propyl)amino]phenol, 4-bis[(3-heneicosyloxy-2-hydroxy-propyl)amino]phenol, 4-bis[(3-docosyloxy-2-hydroxy-propyl)amino]phenol, and 4-bis[(3-tricosyloxy-2-hydroxy-propyl)amino]phenol.

17. The composition of claim 1 wherein the composition is characterized by the ability to inhibit oxidation of oxidizable components in the composition as determined by an induction period, wherein the induction period is measured by Rancimat test Standard Test Method EN 14112, using an air stream that is passed through 7.5 g of a sample of the composition, at a temperature of 110° C. and at an airflow of 10 L/h, and an antioxidant concentration of 1000 ppm, wherein the oxygenated aminophenol antioxidant can prolong the induction time for a period of time that is greater than 50% as compared to the induction time without an antioxidant, or for a period of time that is greater than 60%, 70%, 80%, 90%, 100%, or 110% of the induction time without an antioxidant, and up to 275%, 250%, 225%, 200%, 175%, 160%, 150%, 140%, 130%, or up to 125% as compared to the induction time without an antioxidant.

18. A method for inhibiting oxidation of an ester of a vegetable- or animal-derived fatty acid, or of a vegetable-derived oil in a bio-based fuel or lubricant composition comprising:
adding an aminophenol antioxidant to a composition comprising (ai) an ester of a vegetable- or animal-derived fatty acid, (aii) a vegetable- or animal-derived oil, or both (ai) and (aii), wherein the aminophenol antioxidant is a compound of Formula I 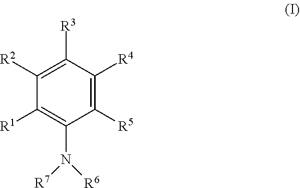
wherein —R¹, —R², —R³, —R⁴, and —R⁵ are independently selected from —H,
—OH, alkyl, aryl, alkyl aryl and aryl alkyl, and —NR⁸R⁹, wherein R⁸ and R⁹ are independently selected from —H, alkyl, aryl, alkyl aryl and aryl alkyl, and R⁶/R⁷ as described herein, or any two adjacent groups of —R¹, —R², —R³, —R⁴, and —R⁵ form one or more ring structures wherein at least one of —R¹, —R², —R³, —R⁴, and —R⁵ is —OH;
wherein one or both of R⁶ and R⁷ is/are (i) a carbon-containing group including one or more hydroxyl group(s) separated from the N atom by one or more carbon atoms; if R⁶ or R⁷ is not (i) then it is selected from —H, alkyl, aryl, alkyl aryl and aryl alkyl.

19. The method of claim 18, wherein the aminophenol antioxidant is present in the composition in an amount in the range of 100 ppm to 2500 ppm, or an amount in the range of 250 ppm to 1500 ppm.

20. The method of claim 18, wherein the composition is characterized by the ability to inhibit oxidation of oxidizable components in the composition as determined by an induction period, wherein the induction period is measured by Rancimat test Standard Test Method EN 14112, using an air stream that is passed through 7.5 g of a sample of the composition, at a temperature of 110° C. and at an airflow of 10 L/h, and an antioxidant concentration of 1000 ppm, wherein the oxygenated aminophenol antioxidant can prolong the induction time for a period of time that is greater than 50% as compared to the induction time without an antioxidant, or for a period of time that is greater than 60%, 70%, 80%, 90%, 100%, or 110% of the induction time without an antioxidant, and up to 275%, 250%, 225%, 200%, 175%, 160%, 150%, 140%, 130%, or up to 125% as compared to the induction time without an antioxidant.
